(19) United States
(12) Patent Application Publication
(10) Pub. No.: US 2018/0278327 A1
(43) Pub. Date: Sep. 27, 2018

(54) A COMMISSIONING DEVICE FOR COMMISSIONING A NEW DEVICE INTO A SYSTEM AND A METHOD THEREOF

(71) Applicant: PHILIPS LIGHTING HOLDING B.V., EINDHOVEN (NL)

(72) Inventors: HUGO JOSE KRAJNC, EINDHOVEN (NL); REMCO MAGIELSE, TILBURG (NL)

(21) Appl. No.: 15/780,946

(22) PCT Filed: Dec. 1, 2016
(86) PCT No.: PCT/EP2016/079457

§ 371 Date: Jun. 1, 2018

(30) Foreign Application Priority Data
Dec. 4, 2015 (EP) 15198025.7

(51) Int. Cl. H04B 10/116; H05B 37/02; H04L 29/06; H04W 76/10

(52) U.S. Cl. CPC H04B 10/116; H04W 76/10; H04L 63/0428; H05B 37/0272

(57) ABSTRACT

A system (100) comprises a device (200) commissioned into the system comprising a light sensor (220) for receiving a first optical data signal from a new device (400) located within an optical range of the device (200), and a commissioning device (300) for communicatively coupling to the device (200). The first optical data signal comprises a unique identifier associated with the new device. The commissioning device (300) comprises a first credential memory (350) for storing system credentials, a commissioning wireless communication unit (320) for receiving from the device (200) the unique identifier, being configured, after receiving the unique identifier, for transmitting the stored system credentials for enabling reception of the system credentials by the new device (400), and for establishing a wireless communication link with the new device based on the unique identifier and the transmitted system credentials for commissioning the new device (400) into the system (100).

### FIELD OF THE INVENTION

The invention relates to a commissioning device, a system comprising the commissioning device, a method of commissioning a new device into a system, a computer program, and a computer readable medium.

### BACKGROUND

At present, lighting systems in various configurations are developed and designed for many purposes, e.g. for general illumination, street illumination, advertisement, emergency lighting and city decoration.

Recently, there has been a fast growing and expanding interest in developing wireless lighting systems, both for professional and residential use. Wireless lighting systems offer several advantages compared to standard cabled lighting systems: comfort, simplicity, lower costs of installation, possibility to be remotely controlled, and a cleaner and more appealing setting.

However, in order to be properly controlled, a wireless lighting system needs to know which devices do belong to the system. The wireless lighting system should exclude from the system devices that do not belong to the system but, for example to a neighboring system or a different system, or to no system at all. In lighting domain, such a setup process is also often called commissioning.

The commissioning process allows all devices to be recognized as part of the system and create a wireless network based on the devices of the system. This process can be monitored by a user via, for example, a user interface. The user can be informed if, for example, any of the devices of the system is missing or malfunctioning. The commissioning process may, for example, allow access of the system only from identified users. One example of such known wireless system is described in US 2014/0265870A1.

US 2014/0265870A1 describes a wireless system that includes a group of light fixtures, each emitting a unique optical data signal and having an ambient light sensor for detecting optical data signals from light fixtures within a visual field of each light fixture. A remote control device (for example a mobile device such as a mobile telephone) detects the unique optical data signals from the light fixtures when the light fixtures are within a visual field of the remote control device and determines the approximate location of such nearby light fixtures via an internal Global Positioning System (GPS) device. A central controller receives a signal from the remote control device and the light fixture, such that one or more visual groups of light fixtures within the lighting system can be identified, commissioned to the system and controlled.

However, the wireless system described in US 2014/0265870A1 suffers from security issues because any light fixture in the system is always commissioned to the system via a direct wireless radio frequency (RF) link with the central controller. In the known system, it is thus possible that new light fixtures that are to be commissioned to the system are hijacked or that new light fixtures of a different system within a RF receiving range of the central controller are erroneously commissioned to the system. In a professional environment this could lead to, e.g., lamps from a different floor or area to get accidentally commissioned to a wrong lighting system; in a residential environment this could lead to, e.g., neighbor's lamps getting added to a different family's lighting system.

Further, the commissioning process described US 2014/0265870A1 is rather burdensome, requiring, based on GPS data, grouping the light fixtures having approximately the same location, then, further based on occupancy data, grouping those light fixtures having the same number of light fixtures within a visual field of each other, and lastly, further based on visual field data, grouping those light fixtures being within a visual field of each light fixture.

### SUMMARY OF THE INVENTION

It would be advantageous to have an improved commissioning process and/or an improved commissioning device for use in the improved commissioning process. An aspect of the invention is a commissioning device as claimed.

The commissioning device is for communicatively coupling to a device commissioned into a system. The device comprises a light sensor for receiving a first optical data signal from a new device located within an optical range of the device. The first optical data signal comprises a unique identifier associated with the new device. The commissioning device comprises a first credential memory for storing system credentials, a commissioning wireless communication unit for receiving from the device the unique identifier associated with the new device. The new device comprises a first light source for emitting the first optical data signal. The commissioning wireless communication unit is configured, after receiving the unique identifier, for transmitting the stored system credentials for enabling reception of the system credentials by the new device.

The commissioning wireless communication unit is further configured for establishing a first wireless communication link with the new device based on the unique identifier and the transmitted system credentials for commissioning the new device into the system.

The risk that a new device not belonging to the system is commissioned to the system has been reduced. New devices can only be commissioned by detecting optical data signals transmitted by the new devices. As a consequence new devices to be commissioned have to be located within an optical range of devices already commissioned into the system. Commissioned devices are already communicatively coupled to the commissioning device. The optical data signals can only be detected by said commissioned devices or the commissioning device. Unique identifiers associated to new devices can be received by the commissioning device via said commissioned devices. The optical data signals emitted by new devices cannot be detected by either other new uncommissioned devices or far devices of other unknown systems, thus the commissioning process is triggered in a more localized space of the commissioned devices, thereby making the overall commissioning process more secure.

In an embodiment, the commissioning device comprises a commissioning provisioning unit. The commissioning provisioning unit is configured for encrypting the stored system credentials with the received unique identifier. The commissioning wireless communication unit is configured for transmitting the encrypted credentials for enabling the new device to decrypt the credentials with the use of its unique identifier.

The risk that an attacker can obtain the system credentials for hijacking the system has been further reduced because the credentials are communicated in an encrypted form which is based on the unique identifier associated with the new device.

In an embodiment, the system comprises the commissioning device and/or the new device.

In an embodiment, the new device comprises a key memory for storing the unique identifier, a new device wireless communication unit configured to receive the encrypted credentials, and a provisioning unit configured to decrypt the received encrypted credentials through the stored unique identifier. The new device wireless communication unit is configured to establish the first wireless communication link with the commissioning wireless communication unit after decryption of the received encrypted credentials.

Wireless communication between the new device and the commissioning device is enabled after that the encrypted credentials are decrypted in the new device. Since decryption is based on the unique identifier, which is securely shared with the commissioning device, a more secure first wireless communication link between the new device and the commissioning device is established.

In an embodiment, the commissioning device is configured to be communicatively coupled to the already commissioned device through the commissioning wireless communication unit via a wireless communication protocol.

The commissioning wireless communication unit is configured to engage in wireless communication with other wireless communication units of new devices after the unique identifiers associated with said new devices are received from the commissioning device, so that also devices far from the commissioning device but within the wireless range of the communication protocol in use, can be controlled in a centralized way via the commissioning device.

In an embodiment, the commissioning device comprises a commissioning light sensor for receiving the first optical data signal from the new device located within an optical range of the commissioning device. In this embodiment, new devices may be commissioned to the system directly via the light sensor of the commissioning device if new devices are within an optical range of the commissioning device.

In an embodiment, the device may have been commissioned before commissioning the new device. To this purpose, the commissioned device may, just like the new device, comprise a second light source for emitting a second optical data signal comprising a second unique identifier associated with the device. The commissioning light sensor may be configured for receiving the second optical data signal, such that the device can be communicatively coupled to the commissioning device.

The commissioned device has already been commissioned to the system via, e.g., its light source which directly sent its unique identifier to the light sensor of the commissioning device.

The commissioned device may thus be a first commissioned device in the system, a new device may subsequently be commissioned via the first commissioned device and other new devices commissioned via the first commissioned device or the subsequently commissioned new devices. For extended systems with multiple commissioned devices, commissioning of new devices can thus have an extended commissioning range. In other words, the commissioning device enables commissioning of other new devices via the commissioned new device. These other new devices are located within an optical range of the commissioned new device. Each commissioned new device acts as a bridge for commissioning other new devices located within an optical range of each commissioned new device. Each time new devices are commissioned, as explained above for a single new device, these new commissioned devices are enabled to directly wirelessly communicate with the commissioning device.

In an embodiment, the new device may be configured to disable the first light source from emitting the first optical data signal after the first wireless communication link between the new device and the commissioning device has been established through for example, the new device wireless communication unit and the commissioning wireless communication unit.

Similarly, the commissioned device may comprise a device wireless communication unit and may be configured to disable the second light source from emitting the second optical data signal after the second wireless communication link between the commissioned device and the commissioning device has been established through, for example, the respective device wireless communication unit and the commissioning wireless communication unit.

By disabling the respective first light source and/or second light source after establishing the first wireless communication link and the second wireless communication link, respectively, malfunctions in the commissioning process may be prevented because the optical data signals are generated only for commissioning new devices. Said malfunctions may for example be caused by cross-coupling of several optical data signals due to multiple reflections or refractions. The system environment is freed up of unnecessary optical data signals, thereby making the system environment less overcrowded of optical data signals and the commissioning process more reliable.

In an embodiment, the system further comprises a controller device for communicatively coupling to the commissioning device for controlling operation of the commissioned device and the new device after the new device has been commissioned.

The controller device is another commissioned device of the system, for example a mobile phone or a remote controller or a wall switch that can communicate wirelessly with the commissioning device and control via the commissioning device, operation of the commissioned devices.

In an embodiment, the system is a lighting system, the commissioned device and the new device are lamps or light fixtures.

Parameters including but not limited to light intensity, light color, color temperature, on and/or off states of the lamps or light fixtures, may be individually controlled by the controller device.

An aspect of the invention concerns a method of commissioning a new device in a system as claimed.

A method according to the invention may be implemented on a computer as a computer implemented method, or in dedicated hardware, or in a combination of both.

Executable code for a method according to the invention may be stored on a computer program product. Examples of computer program products include memory devices, optical storage devices, integrated circuits, servers, online software, etc. Preferably, the computer program product comprises non-transitory program code means stored on a computer readable medium for performing a method according to the invention when said program product is executed on a computer.

In a preferred embodiment, the computer program comprises computer program code means adapted to perform all the steps of a method according to the invention when the computer program is run on a computer. Preferably, the computer program is embodied on a computer readable medium.

Another aspect of the invention provides a method of making the computer program for the method of commissioning available for downloading. This aspect is used when the computer program is uploaded into, e.g., Apple's App Store, Google's Play Store, or Microsoft's Windows Store, and when the computer program is available for downloading from such a store.

### BRIEF DESCRIPTION OF THE DRAWINGS

These and other aspects of the invention are apparent from and will be elucidated with reference to the embodiments described hereinafter. In the drawings,

FIG. 1 shows an example of an embodiment of a wireless system,

FIG. 2 shows an example of an embodiment of a wireless system,

FIG. 3 schematically shows an example of an embodiment of a lighting system,

FIG. 4 schematically shows a flow diagram for a method of commissioning a system,

FIG. 5 schematically shows a computer readable medium having a writable part comprising a computer program according to an embodiment.

Items that have the same reference numbers in different figures, have the same structural features and the same functions, or are the same signals. Where the function and/or structure of such an item has been explained, there is no necessity for repeated explanation thereof in the detailed description.

### DETAILED DESCRIPTION OF EMBODIMENTS

While this invention is susceptible of embodiments in many different forms, there is shown in the drawings and will herein be described in detail one or more specific embodiments, with the understanding that the present disclosure is to be considered as exemplary of the principles of the invention and not intended to limit the invention to the specific embodiments shown and described.

In the following, for the sake of understanding, elements of embodiments are described in operation. However, it will be apparent that the respective elements are arranged to perform the functions being described as performed by them.

Further, the invention is not limited to the embodiments, and the invention lies in each and every novel feature or combination of features described or recited in mutually different dependent claims.

In the following, throughout the entire text, a new device of a system refers to an un-commissioned device, i.e. to a device not yet commissioned to the system and not yet wirelessly controllable within the system, while a device of the system refers to a commissioned device, i.e. to a device already commissioned into the system and already wirelessly controllable within the system.

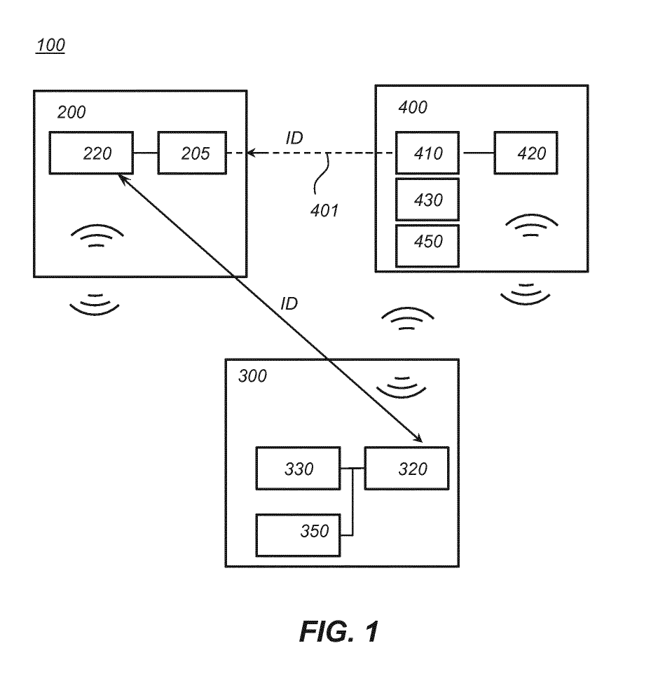

FIG. 1 shows a schematic representation of a first embodiment of a system 100.

The system 100 comprises a device 200 and a commissioning device 300 for communicatively coupling to the device 200. For example, the commissioning device 300 may already communicate wirelessly with the device 200 as indicated by the continuous double arrowed line drawn in FIG. 1.

The device 200 comprises a light sensor 205 for receiving a first optical data signal from a new devices located within an optical range of the device 200.

The commissioning device 300 comprises a first credential memory 350 for storing system credentials.

The commissioning device 300 comprises a commissioning wireless communication unit 330 configured for receiving from the device 200 a unique identifier associated with a new device 400. The new device 400 comprises a first light source 410 for emitting the first optical data signal 401 comprising the unique identifier.

The commissioning wireless communication unit 330 is configured, after receiving the unique identifier, for transmitting the stored system credentials for enabling reception of the system credentials by the new device 400.

The commissioning wireless communication unit 330 is further configured for establishing a first wireless communication link with the new device 400 based on the unique identifier and the transmitted system credentials for commissioning the new device 400 into the system 100.

Since a new device can only be commissioned by detecting the first optical data signal transmitted by the new device, new devices to be commissioned have to be located within an optical range of commissioned devices of the system 100, so that the first optical data signal can only be detected by said commissioned devices and not by either un-commissioned devices or far devices of other unknown systems.

Further, since commissioned devices such as device 200 are already communicating with the commissioning device 300 and not with other devices unknown to the system 100, the commissioning process of new devices via the already commissioned devices is more secure because occurring through an already established, thereby more secure, communication.

The wireless communication unit 320 is configured to engage in wireless communication with other wireless communication units of commissioned devices. Wireless communication unit 320 is configured for some type of wireless communication protocol, e.g. Wi-Fi, Zigbee, Bluetooth or Thread. The first wireless communication link can indeed be any wireless channel since the communication is already secured by triggering the commissioning of the new device by forwarding the unique identifier with the first optical data signal.

The commissioning device 300 can directly send out the system credentials via for example the commissioning wireless communication unit 320, encrypted using the received unique identifier.

In an embodiment, the commissioning device 300 comprises a commissioning provisioning unit 330. The commissioning provisioning unit 330 may be configured to encrypt the stored system credential with the received unique identifier.

The encrypted credentials may be transmitted by the commissioning device 300 via the commissioning wireless communication unit 320 and received directly from the new device 400. For example, the new device may have a new device wireless communication unit 420 configured to receive the system credentials from the commissioning wireless communication unit 320.

In an embodiment, device 200 may comprise a device wireless communication unit 220. The encrypted system credentials may be transmitted to the new device 400 through e.g. the device wireless communication 220.

In a preferred embodiment, the first wireless communication link with the new device 400, through e.g. the new device wireless communication unit 420, may be established only after the commissioning device 300 has received the unique identifier associated with the new device 400 from the device 200.

Having the unique identifier obtained from the first optical data signal and not having the unique identifier transmitted wirelessly through e.g. the new device wireless communication unit 420, ensures that an attacker who does not pick up and interpret the first optical data signal cannot communicate with the new device through the new device wireless communication unit 420 before the commissioning process of the new device is triggered. For example, an attacker could try to impersonate an authorized commissioning device or commissioned device with his smart phone and try to get the new device to connect to a wireless network under control of the attacker through a wireless communication unit of the smart phone, e.g. using credentials for a wireless network of his own, say to his mobile phone. This will not work since the attacker does not have the unique identifier.

The encrypted credentials received wirelessly from commissioning device 300 are decrypted, for example by a provisioning unit 430 of the new device 400, through the unique identifier associated with the new device 400 to obtain the decrypted credentials.

At this point the first wireless communication link between the commissioning device 300 and the new device 400 has been fully established and the new device is commissioned into the system 100 as another device belonging to the system 100.

There are several ways to protect the confidentiality of credentials by encryption using private key encryption. The private key may be the unique identifier associated with the new device 400. The new device 400 may comprise a key memory 450 for storing the private key. The key memory 450 may be a secured memory for securely storing the unique identifier.

The encrypted credentials are then sent to the new device 400. The provisioning unit 430 of the new device 400 may be configured to decrypt the encrypted credentials with the private key (unique identifier).

In an embodiment, the credentials comprise a password required for access to a wireless access point and/or an identifier of the wireless access point. For example, the wireless access point may be a wireless access point configured for the Wi-Fi protocol. The credentials may be the access points Service Set Identifier (SSID) and password. In an embodiment, the credentials may comprise a username and password, or security certificate. In an embodiment, the credentials may be RADIUS access credentials, see e.g. RFC 2865. The credentials may be configured for WPA-Enterprise mode.

The credentials may comprise one or more of the following group: Password, Pre-shared key, Raw public key, Certificate comprising a public key, User Identifying information.

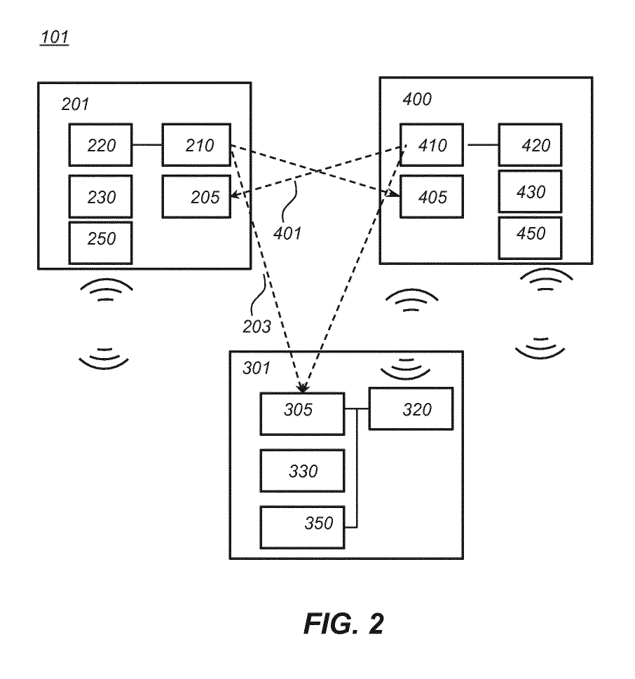

FIG. 2 schematically shows a second example of an embodiment of a system 101. The system 101 comprises a device 201 and a commissioning device 301. A new device 400 is to be commissioned into the system 101. The commissioning device 301 differs from the commissioning device 300 in that the commissioning device 301 further comprises a commissioning light sensor 305 for receiving the first optical data signal from a new device located within an optical range of the commissioning device 301.

In this way new devices may be commissioned directly to the commissioning device 301 via the first optical data signal.

Device 201 may, just like the new device 400 to be commissioned, comprises a second light source 210 for emitting a second optical data signal 203 comprising a second unique identifier of the device 201. Device 201 may comprise a credential memory 250 and a provisioning unit 230.

Device 201 may be located within an optical range of the commissioning device 301. In this case the commissioning light sensor 305 may be configured for receiving the second optical data signal from device 201 for establishing a second wireless communication link with the device 201 before commissioning the new device 401. The device 201 may be a first device to be commissioned in the system 101. After commissioning the device 201, other new devices, e.g. new device 400, located within an optical range of the commissioned device 201 may be commissioned via the commissioned device 201 to the commissioning device 301 as explained with reference to FIG. 1. New device 400 may, similarly to device 201 and commissioning device 301 include a light sensor 405 for receiving optical data signals from other new devices (not shown in FIG. 2) located within an optical range of the new device 400. These other new devices may be commissioned with same procedure explained above for new device 400. Once other new devices are commissioned, these commissioned devices can directly wirelessly communicate with the commissioning device 301. Wireless communication between the commissioning device 301 and new commissioned devices may be established via the commissioning wireless unit 320 and respective wireless communication units (not shown in FIG. 2) of such new commissioned devices.

The device 201 may be used as a bridge in system 101 to commission all new devices located within an optical range of the device 201.

The commissioning devices 300 or 301 and the device 200 or 201 may communicate wirelessly, for example using electromagnetic waves, e.g. in the radio frequency (RF) range or using light communication (VLC) to transmit the digital data to the commissioning device 300.

VLC is a type of optical wireless communication that for example uses a white, infrared or other colored LED. For example, the device 201 may be a light fixture comprising the light source 210. The new device 400 may also be a light fixture with light source 410. The light sources 210, 410 may, e.g., be a fluorescent light source or an LED light source. The light sources 210, 410 may provide both light when the system 101 is in use, and the optical data signals when the respective device 201 and new device 400 are to be commissioned.

In a preferred embodiment, wireless communication between the device 201 and the commissioning device 301 via the second wireless communication link does not include optical communication when the device 201 is already commissioned to the system 101. In this embodiment, commissioning of the new device 401 occurs via the commissioned device 201 only through wireless electromagnetic communication, e.g. through the wireless communication unit 220 via the second wireless communication link.

For example, in an embodiment, the device 201 is configured to disable the second light source 210 from emitting the second optical data signal 203 after the second wireless communication link between the device 201 and the commissioning device 301 has been fully established through for example the wireless communication unit 220, i.e. via wireless electromagnetic (RF) communication.

Similarly, the new device 400 may be configured to disable its light source 410 after the new device 400 has been commissioned to the system 101, i.e. after the unique identifier associated with the new device 400 has been sent to the device 201, or directly to the commissioning device 301, and the credentials have been received by the new device 400.

For example, while sending the encrypted credentials, the commissioning device 301 may send a command signal triggering the disablement of the light source 410.

Alternatively, the commissioning device 301 may send, through e.g. the commissioning wireless communication unit 320, an acknowledgement signal that the new device 400 has been commissioned to the system 101. The new device 400 may be configured to receive the acknowledgement signal and to disable the light source 410 based on the acknowledgement signal.

Since the wireless electromagnetic communication link is established only after that the credentials are sent to the new device and the credentials are encrypted, the established wireless electromagnetic communication link is already secured and more difficult to hijack.

Sensitive information, like the identifiers associated with new devices to be commissioned are transmitted via visual light communication (VLC), thereby sensitive information is transmitted locally within the optical range of the light source 410 and cannot be received by devices outside this optical range. A far user or a far device outside said optical range of the light source 410, i.e. a user or a device that is not in line-of-sight of the new device 400, is unable to receive the unique identifier and thus security is further improved.

Further, by disabling the light source 410 after the new device 400 has been commissioned, malfunctions in the commissioning process which may be caused by cross-coupling of several optical data signals, for example, due to multiple reflections or refractions, are prevented, because the optical data signals are generated only for commissioning new devices. The environment around the system 101 is freed up of unnecessary optical data signals, thereby making the system environment less overcrowded of optical data signals and the commissioning process more reliable.

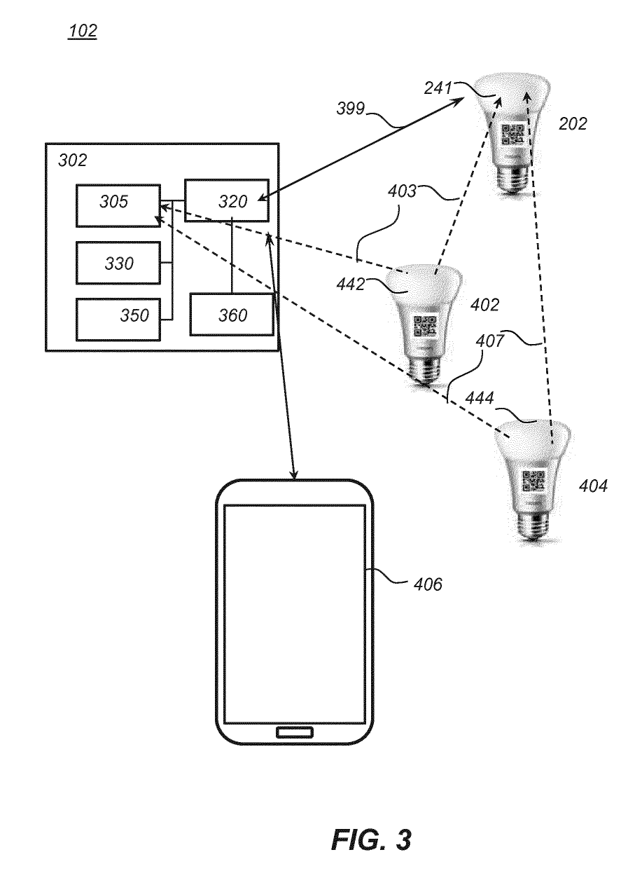

FIG. 3 schematically shows an example of an embodiment of a lighting system 102. The lighting system may include a commissioning device 302, multiple lamps 202, 402, 404 and a controller device 406. Each of the lamps 202, 401 and 402 comprises a respective light source 241, 442 and 444. The controller device 406 and the lamp 202 are already commissioned to the system 102, thereby being communicatively connected with, e.g., the wireless communication unit 320 of the commissioning device 302 with some sort of wireless communication protocol. This is shown in FIG. 3 with a continuous doubled arrowed line indicating the established wireless communication link 399 for the lamp 202. The controller device 406 may also comprise a light source (not shown in FIG. 3) for emitting coded light with an associated unique identifier of the controller device 406. The controller device 406 may have been commissioned into the system 302 with the same procedures as described with reference to the device 400 of FIG. 1.

Lamps 402 and 404 may be new lamps, for example freshly bought out of a store. Once the lamps 402 and 404 are plugged in some sort of light fixtures (not shown in FIG. 3), they start to emit optical data signals 403 and 407 through their light sources 442 and 444. The optical data signal 403 comprises a unique identifier of the lamp 402. The optical data signal 407 comprises a unique identifier of the lamp 403. The optical data signals 403 and 407 may be detected by the light sensor of the lamp 202 or by the light sensor 305 of the commissioning device 302, depending on whether one or both lamps 402 and 404 are within an optical range of the lamp 202 or commissioning device 301. If optical data signals 403 and 407 are detected by the light sensor of the lamp 202, the identifiers of the lamps 402 and 404 are forwarded to the commissioning device 302 by the wireless communication unit of lamp 202 (not shown in FIG. 3) to wireless communication unit 320 of the commissioning device 301.

After receiving the identifiers of the new lamps 402 and 404, the provisioning unit 330 encrypts the system credentials stored in the credential memory 350 based on the received unique identifiers. The encrypted credentials are sent to the lamps 402 and 404 and decrypted therein. Afterwards a wireless communication link between the new lamps 402 and 404 and the commissioning wireless communication unit 320 of the commissioning device 301 can be established and the respective light sources 442 and 444 disabled from emitting coded light.

After all lamps in the system 102 are commissioned, the controller device 406 may be used to control operation of the lamps in the system 102 via a control unit 360 of the commissioning device 302. The controller device 406 may be any type of device with a user interface suitable to send commands to the commissioning device 302, for example a mobile device such as a remote controller or a mobile phone. The controller device 406 may for example control color of the lamps 202, 402 and 404, light intensity, on and off state of the lamps 202, 402 and 404.

The controller device may be also implemented in a non-mobile device, for example a wall switch or wall console from which the user can switch on or off the lamps 202, 402 and 404 of the system 202.

The commissioning device 302 may be a central device, a box with some processing capabilities which centralizes control of the lighting system 102.

The lighting system 102 is thus configured to be self-commissioning once the commissioning device 302 is plugged in some sort of electrical outlet or supplied by a battery, and the lamps 202, 402 and 404 are also plugged in some sort of light fixtures which are also plugged to electrical outlets or are supplied by batteries. As a consequence, self-commissioning occurs without any user intervention, thereby simplifying the commissioning process. The commissioning process is a plug and play process which does not require an instructed user to be capable to operate the system 102. After self-commissioning, the user can, via the controller device 406, control operation of the system 102 in a centralized way. Each lamp 202, 402, 404 may be controlled independently. For example, a number of parameters of each lamp 202, 402, 404 may be controlled, as a color type, e.g. a color temperature, light intensity, on and off status, or any other parameter of the lamps 202, 402, 404.

In an embodiment, the commissioning device 302 may be communicatively coupled to a data network, for example the internet. A firmware of the commissioning device 302 may for example be updated via the internet.

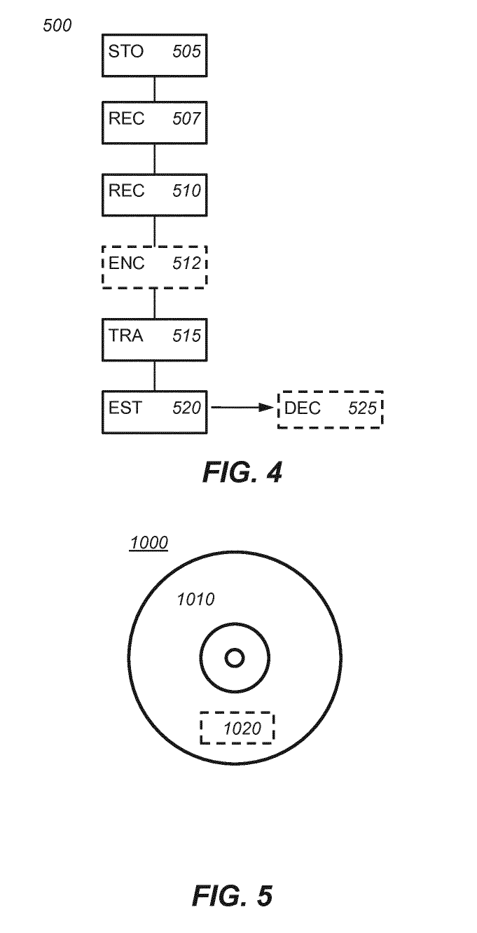

FIG. 4 schematically shows a flow diagram of a method 500 of commissioning a new device in a system. The method may be performed by a commissioning device in cooperation with a device already commissioned in the system. The method 500 comprises
storing (STO, 505) system credentials in a commissioning device being communicatively coupled to a device of the system,
receiving (REC, 507) via a first optical data signal a unique identifier associated with a new device,
receiving (REC, 510) in the commissioning device the unique identifier via the device,
transmitting (TRA, 515) from the commissioning device the stored system credentials for enabling reception of the system credentials by the new device, and
establishing (EST, 520) a first wireless communication link between the commissioning device and the new device based on the unique identifier and the received system credentials for commissioning the new device into the system.
enabling commissioning other new devices into the system via the commissioned new device, the other new devices located within an optical range of the commissioned new device.
   Before transmitting (TRA, 515) from the commissioning device the stored system credentials for enabling reception of the system credentials by the new device, the method may further comprise:
Encrypting (ENC, 512) in the commissioning device the system credentials with the unique identifier.
   Establishing (EST, 520) the first wireless communication link between the commissioning device and the new device may comprise:
Decrypting (DEC, 525) the encrypted system credentials with the use of the unique identifier.

Many different ways of executing the method are possible, as will be apparent to a person skilled in the art. For example, the order of the steps can be varied or some steps may be executed in parallel. Moreover, in between steps other method steps may be inserted. The inserted steps may represent refinements of the method such as described herein, or may be unrelated to the method. Moreover, a given step may not have finished completely before a next step is started.

A method according to an embodiment may be executed using software, which comprises instructions for causing a processor system, e.g. comprising a processing unit, to perform the methods. Software may only include those steps taken by a particular sub-entity of the system. The software may be stored in a suitable storage medium, such as a hard disk, a floppy, a memory etc. The software may be sent as a signal along a wire, or wireless, or using a data network, e.g., the Internet. The software may be made available for download and/or for remote usage on a server. A method may be executed using a bitstream arranged to configure programmable logic, e.g., a field-programmable gate array (FPGA), to perform the method.

It will be appreciated that the invention also extends to computer programs, particularly computer programs on or in a tangible carrier, adapted for putting the invention into practice. The program may be in the form of source code, object code, a code intermediate source and object code such as partially compiled form, or in any other form suitable for use in the implementation of the method according to an embodiment. An embodiment relating to a computer program product comprises computer executable instructions corresponding to each of the processing steps of at least one of the methods set forth. These instructions may be subdivided into subroutines and/or be stored in one or more files that may be linked statically or dynamically. Another embodiment relating to a computer program product comprises computer executable instructions corresponding to each of the means of at least one of the systems and/or products set forth. The computer program may run on a suitable computer, for example on a computer comprising a commissioning wireless communication unit for performing one or more of the steps of the method according to an embodiment of the invention.

FIG. 5 shows a computer readable medium 1000 having a writable part 1010 comprising a computer program 1020, the computer program 1020 comprising instructions for causing a processor system to perform a method of commissioning a new device in a system, according to an embodiment. The computer program 1020 may be embodied on the computer readable medium 1000 as physical marks or by means of magnetization of the computer readable medium 1000. However, any other suitable embodiment is conceivable as well. Furthermore, it will be appreciated that, although the computer readable medium 1000 is shown here as an optical disc, the computer readable medium 1000 may be any suitable computer readable medium, such as a hard disk, solid state memory, flash memory, etc., and may be non-recordable or recordable.

It should be noted that the above-mentioned embodiments illustrate rather than limit the invention, and that those skilled in the art will be able to design many alternative embodiments.

In the claims, any reference signs placed between parentheses shall not be construed as limiting the claim. Use of the verb “comprise” and its conjugations does not exclude the presence of elements or steps other than those stated in a claim. The article “a” or “an” preceding an element does not exclude the presence of a plurality of such elements. The invention may be implemented by means of hardware comprising several distinct elements, and by means of a suitably programmed computer. In the device claim enumerating several means, several of these means may be embodied by one and the same item of hardware. The mere fact that certain measures are recited in mutually different dependent claims does not indicate that a combination of these measures cannot be used to advantage.

1. A lighting system comprising a commissioning device and a plurality of lamps, each lamp of the plurality comprising
a light source for emitting an optical data signal, the optical data signal comprising a unique identifier associated with the lamp,
a light sensor for receiving a further optical data signal from at least one further lamp located within an optical range of the lamp, the further optical data signal comprising a further unique identifier associated with the further lamp,
a lamp wireless communication unit for communicatively coupling with the commissioning device;
the commissioning device comprising
commissioning light sensor for receiving the optical data signal,
a first credential memory for storing system credentials, and
a commissioning wireless communication unit being configured to, after receiving the unique identifier of a first lamp,
transmit the stored system credentials to the first lamp,
for establishing a first wireless communication link with the first lamp based on the unique identifier and the transmitted system credentials for commissioning the first lamp into the system, and wherein the lamp wireless communication unit of the first lamp is configured to, after the first lamp has been commissioned and upon receiving the further unique identifier, send the further unique identifier to the commissioning device via the first wireless communication link for enabling commissioning the further lamp into the system.

2. A system according to claim 1, wherein the commissioning light sensor is configured for receiving the further optical data signal from the further lamp when the further lamp is located within an optical range of the commissioning device.

3. A system according to claim 1, wherein the commissioning device comprises a commissioning provisioning unit configured for encrypting the stored system credentials with the received further unique identifier and wherein the commissioning wireless communication unit is configured for transmitting the encrypted credentials to the further lamp for enabling the further lamp to decrypt the credentials with use of the further unique identifier.

4. A system according to claim 1, wherein the commissioning wireless communication unit is configured to transmit the system credentials directly to the further lamp or via the first lamp to the further lamp.

5. A system according to claim 1, wherein the commissioning device is configured to be communicatively coupled to the first lamp through the commissioning wireless communication unit via a wireless communication protocol.

6. (canceled)

7. (canceled)

8. A system according to claim 1, wherein the commissioned lamp is configured to disable the light source from emitting the optical data signal after the lamp wireless communication unit has been configured to establish the first wireless communication link.

9. A system according to claim 8, further comprising a controller device arranged to be commissioned into the system for communicatively coupling to the commissioning device for controlling operation of the first lamp and the further lamp after the further lamp has been commissioned.

10. (canceled)

11. A system according to claim 3, wherein the further lamp comprises:
a key memory for storing the further unique identifier,
the further lamp wireless communication unit being configured to receive the encrypted credentials, and to establish a second wireless communication link with the commissioning wireless communication unit, and
a provisioning unit configured to decrypt the received encrypted credentials through the stored further unique identifier.

12. A system according to claim 11, further comprising a controller device, wherein the controller device comprises a light source for emitting an optical data signal comprising a controller unique identifier for commissioning the controller device into the system and a controller wireless unit for enabling communication with the commissioning device for controlling, after commissioning the controller device, the operation of the first lamp and further lamp.

13. (canceled)

14. A method of commissioning new devices in a system, the system comprising a commissioning device and a plurality of lamps, the method comprising
emitting an optical data signal from a first lamp, the optical data signal comprising a unique identifier associated with the first lamp,
storing system credentials in the commissioning device,
receiving via the unique identifier by the commissioning device,
transmitting from the commissioning device the stored system credentials to the first lamp for enabling reception of the system credentials by the new device, and
establishing a first wireless communication link between the commissioning device and the first lamp based on the unique identifier and the received system credentials for commissioning the first lamp into the system,
emitting a further optical data signal from a further lamp, the further optical data signal comprising a further unique identifier associated with the further lamp,
receiving the further unique identifier by the first lamp,
sending the further unique identifier by the first lamp to the commissioning device via the first wireless link,
enabling commissioning the further lamp into the system.

15. A computer program comprising computer program instructions arranged to perform the method of claim 14 when the computer program is run on a computer, the computer comprising a commissioning wireless communication unit for performing one or more steps of the method of claim 14.

16. A computer readable medium comprising the computer program as in claim 15.

17. A lamp for commissioning a further lamp into a system, the system comprising a plurality of lamps and a commissioning device, the commissioning device comprising
a commissioning light sensor for receiving an optical data signal, the optical data signal comprising a unique identifier of the lamp,
a first credential memory for storing system credentials, and
a commissioning wireless communication unit being configured, after receiving the unique identifier, for transmitting the stored system credentials to the first lamp, for establishing a first wireless communication link with the first lamp based on the unique identifier and the transmitted system credentials for commissioning the lamp into the system;
the lamp comprising
a light source for emitting an optical data signal, the optical data signal comprising the unique identifier associated with the lamp,
a light sensor for receiving a further optical data signals from at least a further lamp located within an optical range of the lamp, the further optical data signal comprising a further unique identifier associated with the further lamp,
a lamp wireless communication unit for communicatively coupling with the commissioning device and configured to, after the lamp has been commissioned and upon receiving the further unique identifier, send the further unique identifier to the commissioning device via the first wireless communication link for enabling commissioning the further lamp into the system.
